(19) United States
(12) Patent Application Publication
(10) Pub. No.: US 2023/0315468 A1
(43) Pub. Date: Oct. 5, 2023

(54) ENFORCING CONSISTENCY ACROSS REDUNDANT TAGGED GEOMETRIC (TAGE) BRANCH HISTORIES

(71) Applicant: ADVANCED MICRO DEVICES, INC., Santa Clara, CA (US)

(72) Inventors: ANTHONY JARVIS, BOXBOROUGH, MA (US); THOMAS CLOUQUEUR, BOXBOROUGH, MA (US); QIAN MA, BOXBOROUGH, MA (US)

(21) Appl. No.: 17/708,318

(22) Filed: Mar. 30, 2022

(51) Int. Cl. G06F 9/38; G06F 9/30

(52) U.S. Cl. CPC G06F 9/3806; G06F 9/30058

(57) ABSTRACT

Enforcing consistency across redundant tagged geometric (TAGE) branch histories, including: determining, by a TAGE branch predictor, whether a predefined interval has occurred; and storing, in a retirement branch history, in response to the predefined interval occurring, a copy of a global branch history.

### BACKGROUND

Some implementations of tagged geometric (TAGE) branch predictors use redundant instances of branch histories, one for generating predictions and one for training the branch predictor. These redundant histories are maintained as duplicate copies of each other but are used at different points in the branch prediction pipeline. As these redundant instances of the branch history should be duplicate copies of each other, cohesion between the redundant instances of the branch history should be maintained to ensure proper performance.

### BRIEF DESCRIPTION OF THE DRAWINGS

FIG. 1 is a block diagram of an apparatus including an example TAGE branch predictor for enforcing consistency across redundant TAGE branch histories according to some implementations.

FIG. 2 is a block diagram of an example tagged geometric (TAGE) branch predictor for enforcing consistency across redundant TAGE branch histories according to some embodiments.

FIG. 3 is diagram of an example TAGE table for enforcing consistency across redundant TAGE branch histories according to some embodiments.

FIG. 4 is diagram of an example global branch history for enforcing consistency across redundant TAGE branch histories according to some embodiments.

FIG. 5 is diagram of an example computer for enforcing consistency across redundant TAGE branch histories according to some embodiments.

FIG. 6 is a flowchart of an example method for enforcing consistency across redundant TAGE branch histories according to some embodiments.

FIG. 7 is a flowchart of another example method for enforcing consistency across redundant TAGE branch histories according to some embodiments.

### DETAILED DESCRIPTION

Some implementations of tagged geometric (TAGE) branch predictors use redundant instances of branch histories. For example, a first instance of branch history is used for generating predictions, while a second instance of branch history is used to train the TAGE branch predictor on retirement of a branch instruction. These redundant instances should maintain cohesion to ensure proper performance. In some circumstances, due to various errors, bugs, and the like, a variance is introduced between these redundant representations. Such a variance introduces the possibility of errors in branch prediction, performance degradation, and the like.

The present specification sets forth various implementations for enforcing consistency across redundant TAGE branch histories. In some embodiments, a method for enforcing consistency across redundant TAGE branch histories includes. The method also includes determining, by a TAGE branch predictor, whether a predefined interval has occurred. The method further includes storing, in a retirement branch history, in response to the predefined interval occurring, a copy of a global branch history.

In some embodiments, the method further includes updating, in response to retirement of a branch instruction, one or more TAGE tables based on the retirement branch history storing the copy of the global branch history. In some embodiments, the method further includes updating the retirement branch history based on a prediction for the branch instruction. In some embodiments, the prediction is based on the global branch history as copied into the retirement branch history. In some embodiments, the predefined interval includes a number of prediction cycles. In some embodiments, the predefined interval includes a time interval. In some embodiments, the global branch history and the retirement branch history are each implemented as a circular buffer.

The present specification also describes various implementations for a TAGE branch predictor for enforcing consistency across redundant TAGE branch histories. Such a TAGE branch predictor includes: a global branch history and a retirement branch history. The TAGE branch predictor performs steps including: determining whether a predefined interval has occurred, and storing, in the retirement branch history, in response to the predefined interval occurring, a copy of the global branch history.

In some embodiments, the steps further include updating, in response to retirement of a branch instruction, one or more TAGE tables based on the retirement branch history storing the copy of the global branch history. In some embodiments, the steps further include updating the retirement branch history based on a prediction for the branch instruction. In some embodiments, the prediction is based on the global branch history as copied into the retirement branch history. In some embodiments, the predefined interval includes a number of prediction cycles. In some embodiments, the predefined interval includes a time interval. In some embodiments, the global branch history and the retirement branch history are each implemented as a circular buffer.

Also described in this specification are various implementations of an apparatus for enforcing consistency across redundant TAGE branch histories. Such an apparatus includes computer memory and a processor operatively coupled to the computer memory. The processor includes a TAGE branch predictor. The TAGE branch predictor performs steps including: determining whether a predefined interval has occurred, and storing, in a retirement branch history, in response to the predefined interval occurring, a copy of a global branch history.

In some embodiments, the steps further include updating, in response to retirement of a branch instruction, one or more TAGE tables based on the retirement branch history storing the copy of the global branch history. In some embodiments, the steps further include updating the retirement branch history based on a prediction for the branch instruction. In some embodiments, the prediction is based on the global branch history as copied into the retirement branch history. In some embodiments, the predefined interval includes a number of prediction cycles. In some embodiments, the predefined interval includes a time interval.

The following disclosure provides many different implementations, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows include implementations in which the first and second features are formed in direct contact, and also include implementations in which additional features be formed between the first and second features, such that the first and second features are not in direct contact. Further, spatially relative terms, such as “beneath,” “below,” “lower,” “above,” “upper,” “back,” “front,” “top,” “bottom,” and the like, are used herein for ease of description to describe one element or feature's relationship to another element(s) or feature(s) as illustrated in the figures. Similarly, terms such as “front surface” and “back surface” or “top surface” and “back surface” are used herein to more easily identify various components, and identify that those components are, for example, on opposing sides of another component. The spatially relative terms are intended to encompass different orientations of the device in use or operation in addition to the orientation depicted in the figures.

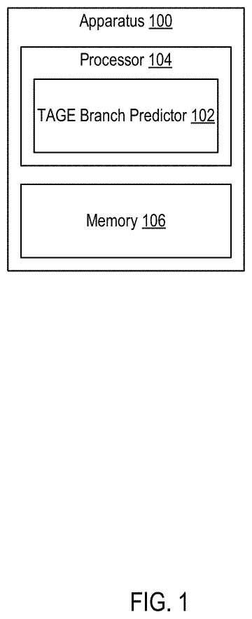

FIG. 1 is a block diagram of an apparatus 100 including an example tagged geometric (TAGE) branch predictor 102 for enforcing consistency across redundant TAGE branch histories. The apparatus 102 can be implemented as a variety of computing devices, including personal computers, mobile devices, servers, systems-on-a-chip (SoCs), hardware accelerators, and the like. The apparatus 100 is a processor 104 such as a central processing unit (CPU) or other processor 104 as can be appreciated. The apparatus 100 also includes memory 106 operatively coupled to the processor 104. The memory 106 includes, for example, volatile memory such as random access memory (RAM), non-volatile memory, disk-based storage, or combinations thereof.

The processor 104 includes a TAGE branch predictor 102 for enforcing consistency across redundant TAGE branch histories according to some implementations described in further detail below. The TAGE branch predictor 102 performs a branch prediction on instructions provided to the processor 104 for execution (e.g., instructions loaded from memory 106). The TAGE branch predictor 102 uses a TAGE algorithm to perform branch prediction as will be described in further detail below.

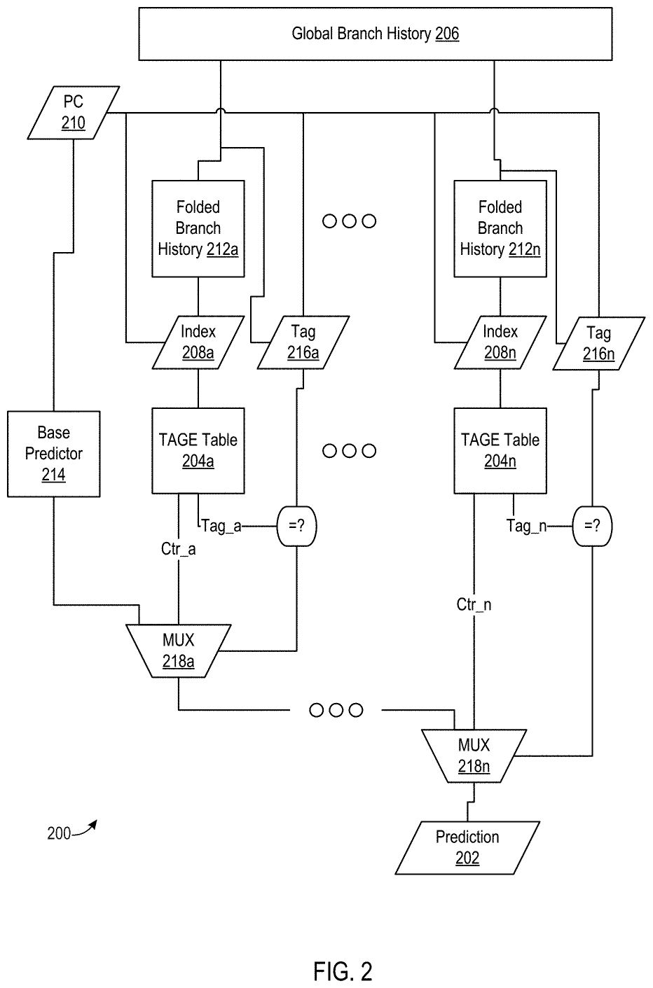

FIG. 2 is a block diagram of a non-limiting example tagged geometric (TAGE) branch predictor such as the TAGE branch predictor 102 of FIG. 1. The example TAGE branch predictor 200 of FIG. 2 can be implemented in a variety of processors, cores, and other computer hardware components as can be appreciated. The TAGE branch predictor 200 uses a TAGE branch prediction algorithm as would be appreciated by one skilled in the art to generate, for a given branch instruction, a prediction 202. The prediction 202 is a prediction of whether or not a branch in the branch instruction will be taken. In other words, the prediction 202 is a prediction of whether or not a particular condition that will trigger a conditional branch will be satisfied.

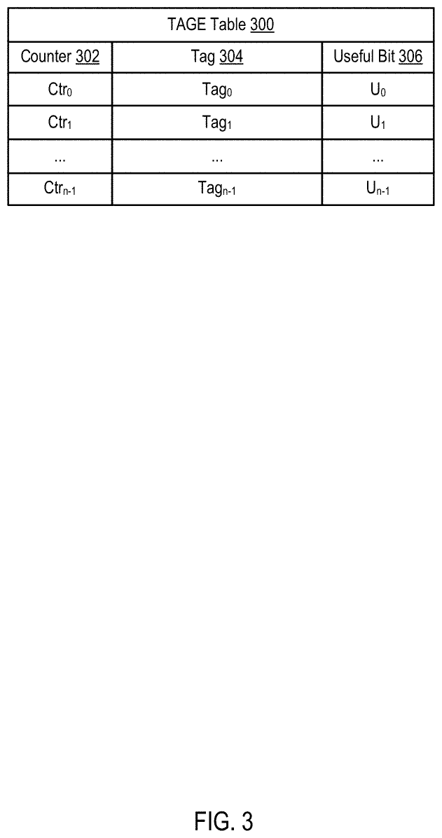

To generate the prediction 202, the TAGE branch predictor 200 maintains multiple TAGE tables 204a-n. Each TAGE table 204a-n is a logical table that includes a plurality of entries. As will be described in further detail below, each TAGE table 204a-n is indexed based on an increasingly long portion of branch prediction history, with the utilized lengths of branch prediction history increasing according to a geometric sequence. As is shown in the example TAGE table 300 of FIG. 3, each entry of the TAGE table 300 includes a counter 302 and a tag 304. The use of the counter 302 and tag 304 for a given entry in generating the prediction 202 is described in further detail below. Each entry also includes a useful bit 306 that, if set, prevents modification of the corresponding entry. In some implementations, the useful bit 306 is overridden to allow modification of the corresponding entry.

The history used by the TAGE branch predictor 200 is shown as the global branch history 206. The global branch history 206 is a data structure or portion of memory including a plurality of entries each indicating whether a branch was taken or not taken. As an example, each entry is a single bit, with a “1” indicating a taken branch and a “0” indicating a non-taken branch. For a global branch history 206 with N entries, the global branch history 206 then stores the N-most recent branch decisions. In some implementations, the global branch history 206 includes a path history. A register value for a path history is shifted for all branch types so long as their direction is taken, typically shift by two or three bits at a time. Instead of shifting in the direction of a branch at the lowest position, a portion of the address of the last byte in the instruction is XORed into the register, allowing some overlap with the previous values at the low position.

As the global branch history 206 is of limited size, after the global branch history 206 is full, an oldest entry should be removed when a newest entry is added. In existing solutions, prediction branch histories 206 are stored using an N-bit shift register. When a new entry is added to the global branch history 206, the entire register is shifted by a single bit and a bit is stored at the new head of the register. The amount of power required to perform this bit shift increases as the size of the shift register increases. Accordingly, a large global branch history 206 using a shift register would require a large amount of power to shift the register for each update to the global branch history 206.

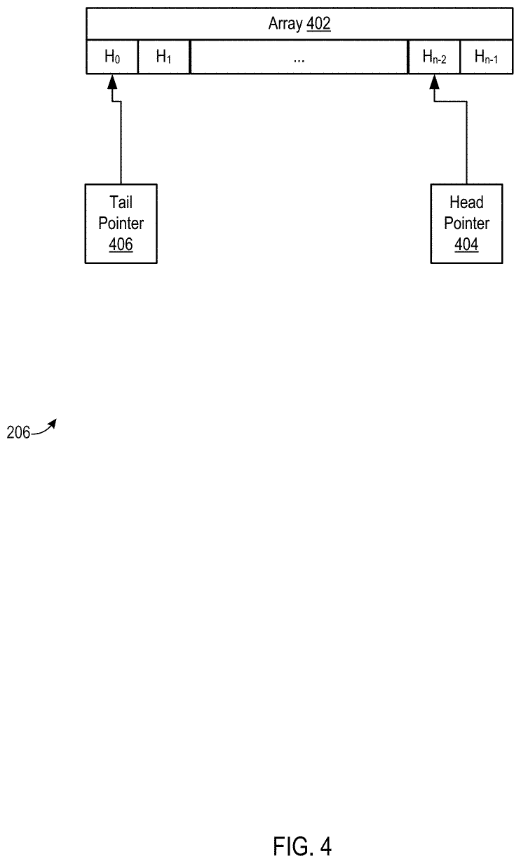

To address this concern, in some implementations, the global branch history 206 is instead implemented using an array 402 as shown in FIG. 4. The array 402 is implemented, for example, as a latch array, a flip-flop array, as an allocated portion of static random access memory (SRAM), and the like. Each entry in the array 402 is a single bit. Instead of shifting entries as with a shift register, the global branch history 206 maintains a head pointer 404 identifying a newest entry in the array 402 and a tail pointer 406 identifying an oldest entry in the array 402. In other words, the global branch history 206 is implemented as a circular buffer. Although FIG. 4 shows the head pointer 404 identifying entry Hₙ₋₂ and the tail pointer 406 identifying entry H₀, one skilled in the art will appreciate that this is only for illustrative purposes and that the particular entries identified by the head pointer 404 and tail pointer 406 will change as the global branch history 206 is updated.

Consider an example where the head pointer 404 identifies entry Hₙ₋₂ and the tail pointer 406 identifies entry H₀, with entry Hₙ₋₁ currently unused. An update to the global branch history 206 will then cause a value to be stored at entry Hₙ₋₁ and the head pointer 404 to be updated to identify the entry Hₙ₋₁. The array 402 is now full, with all entries storing a value for the global branch history 206. Another update will require an oldest value to be removed from the array 402. Accordingly, in response to another update, the tail pointer 406 will be updated to identify entry Hi, the head pointer 404 will be updated to identify entry H₀, and the value for the update will then be stored at entry H₀. Additional updates will continue to cause the head pointer 404 and tail pointer 406 to be updated, with the value for the latest update to be stored at the entry identified by the updated head pointer 404.

As will be appreciated by one skilled in the art, updating a global branch history 206 implemented using an array 402, head pointer 404 and tail pointer 404 only requires modification of a single entry in the array 402 and updates to the head pointer 404 and, if the array 402 is full, the tail pointer 404. This provides considerable power savings when compared to shifting a shift register of sufficiently large size.

An entry for a given TAGE table 204a-n is identified using an index 208a-n. An index 208a-n is calculated as a function of the program counter (PC) 210 (e.g., identifying the address of the branch instruction subject to prediction) and a portion of the global branch history 206, with each TAGE table 204a-n having its corresponding index 208a-n calculated using portions of the global branch history 206 of geometrically increasing length. For example, the PC 210, or a subset of the bits of the PC 210, are combined with the bits of the global branch history 206 used for the given index 208a-n using a hash function, an exclusive-OR (XOR) function, or other function. Although the following discussion will use the term “hashing” when combining the PC 210 with bits from the global branch history 206, it is understood that this encompasses the use of XOR functions or other aggregate functions usable in combining the PC 210 with portions of the global branch history 206 to generate an index 208a-n.

As the number of global branch history 206 bits used for a given TAGE table 204a-n (hereinafter referred to as “history bits”) increases, the number of history bits used will exceed the number of bits needed to index a TAGE table 204a-n (e.g., to identify a particular entry in the TAGE table 204a). For example, a TAGE table 204a-n with 2024 entries only needs ten bits to identify any of the entries. Accordingly, before hashing the PC 210 with the history bits, in some implementations the used history bits are “folded” on themselves to generate a folded branch history 212a-n.

The history bits are “folded” by subdividing the history bits into portions of equal length (e.g., corresponding to the number of bits needed to identify an entry in the TAGE table 204a-n) and then applying an XOR function to combine each of the portions into a single portion. Assuming N history bits used for a given TAGE table 204a-n and assuming M bits are needed to identify an entry in the TAGE table 204a-n, the N history bits are divided into N/M portions of M bits and XOR-ed together to create a single folded branch history 212a-n of M bits. For example, assume that a given TAGE table 204a-n with 1024 entries (therefore needing 10 bits to index) uses 500 bits of the global branch history 206. These 500 bits are divided into fifty 10-bit portions. These fifty portions are then XOR-ed together to create a single 10-bit folded branch history 212a-n from which an index 208a-n is generated. Where the history bits are not evenly dividable by the number of bits used for indexing, in some implementations, the history bits are padded (e.g., with one or more zeroes) until the history bits are of a length that is a factor of the number of bits used for indexing.

In some implementations, a folded branch history 212a-n for each TAGE table 204a-n is calculated from the global branch history 206 each time a branch prediction is to be performed. However, this requires significant computational and time resources, and would require a large number of XOR gates in order to be implemented in hardware as the size of the global branch history 206 grows. Instead, in some implementations, the TAGE branch predictor 200 includes allocated portions of memory to logically store the folded branch history 212a-n for each TAGE table 204a-n. When the global branch history 206 is updated, instead of recalculating the folded branch history 212a-n for each TAGE table 204a-n, the stored folded branch histories 212a-n are modified to reflect the update (e.g., by shifting or rotating the folded branch history 212a-n, modifying one or more bits in the shifted value, accessing particular bits in the global branch history 206 to calculate particular bits in the folded branch history 212a-n, etc.). Thus, the folded branch history 212a-n for each TAGE table 204a-n is maintained without the need to fully recalculate each folded branch history 212a-n on an update to the global branch history 206.

In addition to the TAGE tables 204a-n, the TAGE branch predictor 200 also maintains a base predictor 214. The base predictor 214 is a table of counters indexed using the PC 210 that will provide a default prediction 202 if no entries in the TAGE tables 204a-n match the calculated indexes 208a-n.

To generate a prediction 202 for a given branch instruction, the TAGE branch predictor 200 calculates, for each TAGE table 204a-n, a tag 216a-n. Each tag 216a-n is calculated as a function (e.g., by hashing, XOR-ing, and the like) of the PC 210 and the bits of the global branch history 206 used by the corresponding TAGE table 204a-n. Though the indexes 208a-n and tags 216a-n are both generated as a function of the PC 210, the particular functions used to calculate the indexes 208a-n and tags 216a-n are different. For example, in some implementations, tags 216a-n and indexes 208a-n are of different lengths. Accordingly, in some implementations, a tag 216a-n for a given TAGE table 204a-n is calculated by folding the bits of the global branch history 206 used by that TAGE table 204a-n using portions having a number of bits equal to the number of bits used in a given tag 216a-n.

For each TAGE table 204a-n, where an entry is found at the corresponding index 208a-n, a counter 302 value is provided to a corresponding multiplexer (MUX) 218a-n, shown in FIG. 2 as Ctr_a, Ctr_n. Moreover, where an entry is found at the corresponding index 208a-n, a tag 304 for the entry (shown as Tag_a, Tag_n) is compared to the calculated tag 216a-n. The result of the comparison is provided as a selector signal to the corresponding MUX 218a-n. Thus, where the tag 304 for the entry is equal to the calculated tag 216a-n, the MUX 218a-n outputs the counter 302 output by the MUX 218a-n. Where the tag 304 for the entry is not equal to the calculated tag 216a-n, or no entry is found, the MUX 218a-n provides, as output, an input received from a preceding MUX 218a-n or, in the case of the first MUX 218a, an input from the base predictor 214. The output of the last MUX 218n then serves as the prediction 202. The global branch history 206 is updated to reflect the result of the prediction 202 (e.g., a new entry is added to indicate whether it is predicted that the branch will or will not be taken).

After retirement of a branch instruction through the execution pipeline, the TAGE tables 204a-n are updated depending on whether the prediction 202 was correct. For example, where the prediction 202 was correct, the TAGE table 204a-n entries used to generate the prediction 202 are updated by incrementing a counter 302 for a taken branch or decrementing a counter 302 for a non-taken branch. Additionally, in some embodiments, a useful bit 306 for the entry is set to protect it from being overwritten by other training. As another example, where the prediction 202 was incorrect, the TAGE table 204a-n entries used to generate the prediction are updated by decrementing a counter 302 for a non-taken branch or decrementing a counter 302 for a taken branch. Additionally, for TAGE tables 204a-n where no entry was found (e.g., that use longer history) new entries are allocated.

To identify the TAGE table 204a-n entries to update, the indexes 208a-n are recalculated using the address of the branch instruction being retired and the particular history bits for the TAGE table 204a-n. In some embodiments, the TAGE branch predictor 200 maintains a second copy of the global branch history 206 hereinafter referred to as the retirement branch history 220. The retirement branch history 220 is implemented, for example, as a circular buffer. Although the retirement branch history 220 is described as using a circular buffer, it is understood that, in some embodiments, the global branch history 206 and retirement branch history 220 are implemented using other approaches, such as shift register or another approach. For example, the global branch history 206 is updated when a prediction 202 is generated, with a new entry in the global branch history 206 reflecting the predicted branch (e.g., whether it is predicted that the branch will or will not be taken). The retirement branch history 220 is used to calculate indexes 208a-n for identifying the TAGE table 204a-n entries to be updated based on whether the prediction 202 was correct. The retirement branch history 220 is then updated on retirement of a branch instruction to reflect the prediction 202 for the retired branch instruction.

In order to correctly identify the TAGE table 204a-n entries to be updated, the global branch history 206 and the retirement branch history 220 should maintain cohesion. That is, the state of the global branch history 206 used to generate a prediction 202 for a given branch instruction should match the state of the retirement branch history 220 when the branch instruction is retired. In some circumstances, due to various errors, bugs, and the like, a variance is introduced between the global branch history 206 and the retirement branch history 220. Such a variance introduces the possibility of errors in branch prediction, performance degradation, and the like. Where large circular buffers are used for the global branch history 206 and retirement branch history 220, the variances introduced have the potential of staying for long periods of time, prolonging the performance degradation.

To address this concern, the TAGE branch predictor 200 periodically forces coherency between the global branch history 206 and the retirement branch history 220 by storing, in the retirement branch history 220, a copy of the global branch history 206. In some embodiments, the predefined interval is a number of prediction cycles. In other words, every Nth branch instruction for which a prediction 202 is to be generated, the global branch history 206 is copied into the retirement branch history 220. In some embodiments, the predefined interval is a time interval or a number of clock cycles. In some embodiments, the predefined interval is a predefined number of instructions executed. One skilled in the art will appreciate that various intervals or criteria are usable in triggering the copying of the global branch history 206 into the retirement branch history 220.

The TAGE branch predictor 200 uses the global branch history 206 as copied into the retirement branch history 220 to generate a prediction 202 for a given branch instruction as described above. After generating the prediction, the global branch history 206 is updated to reflect the prediction 202. On retirement of the given branch instruction, one or more TAGE tables 204a-n are updated based on the retirement branch history 220 storing the copy of the global branch history 206. The retirement branch history 220 is then updated based on the prediction 202 for the retired branch instruction as described above.

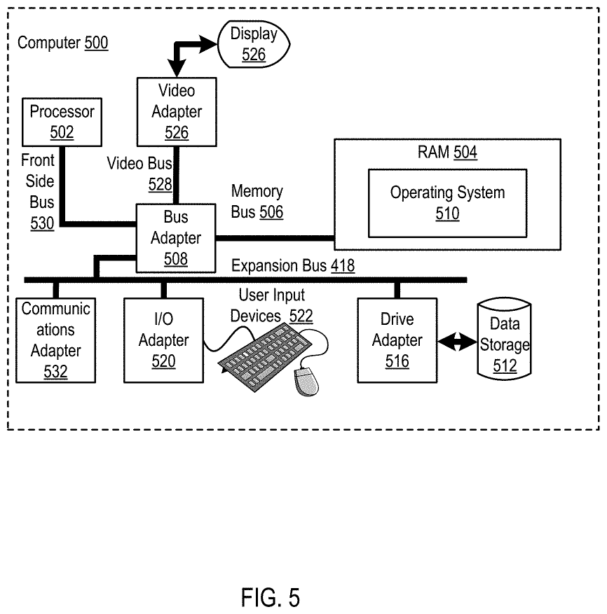

In some implementations, the TAGE branch predictor 200 of FIG. 2 is implemented in a computer 500. For example, the TAGE branch predictor 200 is implemented in at least one processor 502. In addition to at least one processor 502, the computer 500 of FIG. 5 includes random access memory (RAM) 504 which is connected through a high speed memory bus 506 and bus adapter 508 to processor 502 and to other components of the computer 500. Stored in RAM 504 is an operating system 510. The operating system 510 in the example of FIG. 5 is shown in RAM 504, but many components of such software typically are stored in non-volatile memory also, such as, for example, on data storage 512, such as a disk drive.

The computer 500 of FIG. 5 includes disk drive adapter 516 coupled through expansion bus 518 and bus adapter 508 to processor 502 and other components of the computer 500. Disk drive adapter 516 connects non-volatile data storage to the computer 500 in the form of data storage 512. Such disk drive adapters include Integrated Drive Electronics (‘IDE’) adapters, Small Computer System Interface (SCSI′) adapters, and others as will occur to those of skill in the art. In some implementations, non-volatile computer memory is implemented as an optical disk drive, electrically erasable programmable read-only memory (so-called ‘EEPROM’ or ‘Flash’ memory), RAM drives, and so on, as will occur to those of skill in the art.

The example computer 500 of FIG. 5 includes one or more input/output (′I/O′) adapters 520. I/O adapters implement user-oriented input/output through, for example, software drivers and computer hardware for controlling output to display devices such as computer display screens, as well as user input from user input devices 522 such as keyboards and mice. The example computer 500 of FIG. 5 includes a video adapter 524, which is an example of an I/O adapter specially designed for graphic output to a display device 526 such as a display screen or computer monitor. Video adapter 524 is connected to processor 502 through a high speed video bus 528, bus adapter 508, and the front side bus 530, which is also a high speed bus.

The exemplary computer 500 of FIG. 5 includes a communications adapter 532 for data communications with other computers and for data communications with a data communications network. Such data communications are carried out serially through RS-232 connections, through external buses such as a Universal Serial Bus (‘USB’), through data communications networks such as IP data communications networks, and/or in other ways as will occur to those of skill in the art. Communications adapters 532 implement the hardware level of data communications through which one computer sends data communications to another computer, directly or through a data communications network. Such communication adapters 532 include modems for wired dial-up communications, Ethernet (IEEE 802.3) adapters for wired data communications, and 802.11 adapters for wireless data communications.

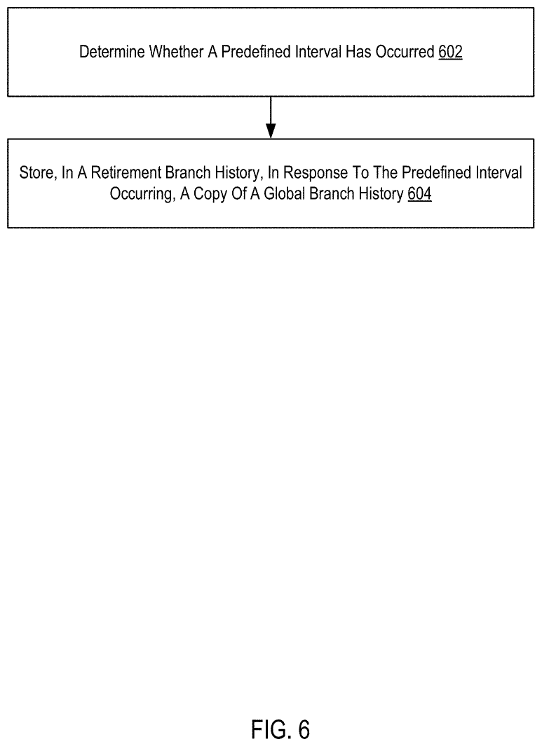

For further explanation, FIG. 6 sets forth a flow chart illustrating an example method for enforcing consistency across redundant TAGE branch histories according to some embodiments of the present disclosure. The method of FIG. 6 is performed, for example, by a TAGE branch predictor such as the example TAGE branch predictor 200 of FIG. 2. The method of FIG. 6 includes determining 602 whether a predefined interval has occurred. In some embodiments, determining 602 whether the predefined interval has occurred is performed in response to beginning a branch prediction cycle. For example, the TAGE branch predictor receives a memory address of a branch instruction for which a prediction is to be generated, thereby beginning the branch prediction cycle. In some embodiments, the predefined interval is a number of prediction cycles. In other words, the predefined interval is deemed to occur every N prediction cycles. In some embodiments, the predefined interval is a time interval or a number of clock cycles. In some embodiments, the predefined interval is a number of fetched instructions. One skilled in the art will appreciate that, in some embodiments, other criteria are used to define the predefined interval.

The method of FIG. 6 also includes storing 604, in a retirement branch history, in response to the predefined interval occurring, a copy of the global branch history. The global branch history is a data structure or memory allocation that stores a history of generated predictions. In other words, after a prediction is generated, an entry is added to the global branch history indicating whether the prediction predicts that a branch will or will not be taken. The global branch history is also used by the TAGE branch predictor to generate predictions. The retirement branch history also stores a history of generated predictions. In contrast to the global branch history that is updated after generating a prediction, the retirement branch history is updated at retirement of a branch instruction to indicate the prediction for that branch instruction. The retirement branch history is used to train the TAGE branch predictor as will be described in further detail below.

In response to the predefined interval occurring, a copy of the global branch history is copied into the retirement branch history in order to periodically force cohesion between the global branch history and the retirement branch history. For example, entries in the global branch history are each copied into the retirement branch history, thereby overwriting any existing entries in the retirement branch history. Moreover, any pointers (e.g., head and tail pointers) for the retirement branch history are updated to identify the newest and oldest entries, respectively, in the retirement branch history.

The state of the global branch history used to generate a prediction for a given branch instruction (e.g., prior to updating the global branch history to reflect the generated prediction) should match the state of the retirement branch history when the branch instruction is retired (e.g., prior to updating the retirement branch history with the prediction for that branch instruction). In some circumstances, due to various errors, bugs, and the like, a variance is introduced between the global branch history and the retirement branch history. Such a variance introduces the possibility of errors in branch prediction, performance degradation, and the like. Where large circular buffers are used for the global branch history and retirement branch history, the variances introduced have the potential of staying for long periods of time, prolonging the performance degradation. Accordingly, periodically copying the global branch history into the retirement branch history ensures that any variances or differences between the global branch history or the retirement branch history are eliminated.

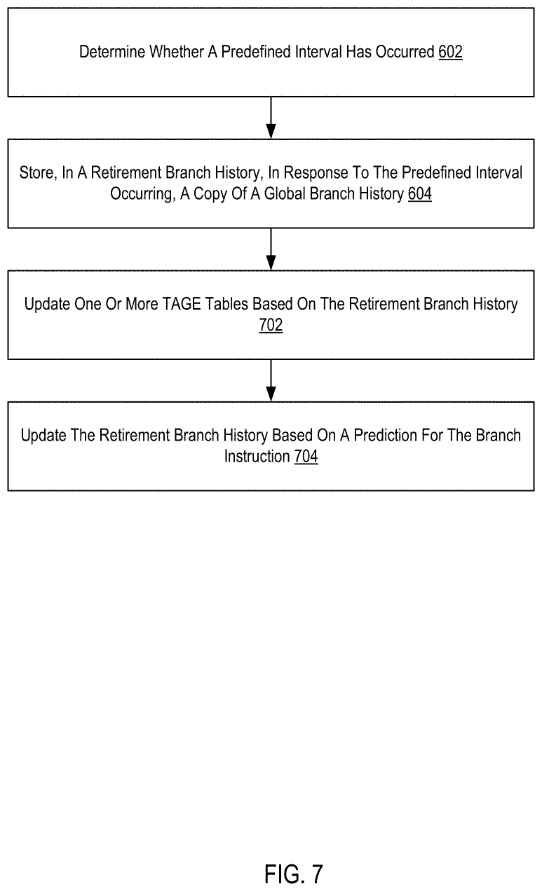

For further explanation, FIG. 7 sets forth a flow chart illustrating an example method for enforcing consistency across redundant TAGE branch histories according to some embodiments of the present disclosure. The method of FIG. 7 also includes updating 702 one or more TAGE tables based on the retirement branch history. The one or more TAGE tables are updated on retirement of a branch instruction depending on whether the generated prediction for that branch instruction was correct. For example, where the prediction was correct, the TAGE table entries used to generate the prediction are updated by incrementing a counter for a taken branch or decrementing a counter for a non-taken branch. Additionally, in some embodiments, a useful bit for the entry is set to protect it from being overwritten by other training. As another example, where the prediction was incorrect, the TAGE table entries used to generate the prediction are updated by decrementing a counter for a non-taken branch or decrementing a counter for a taken branch. Additionally, for TAGE tables where no entry was found (e.g., that use longer history) new entries are allocated.

To identify the TAGE table entries to update, the indexes are recalculated using the address of the branch instruction being retired and the particular history bits for the TAGE table as stored in the retirement branch history. In some embodiments, the TAGE branch predictor maintains a second copy of the global branch history hereinafter referred to as the retirement branch history. The retirement branch history is implemented, for example, as a circular buffer. Although the retirement branch history is described as using a circular buffer, it is understood that, in some embodiments, the global branch history and retirement branch history are implemented using other approaches, such as shift register or another approach. For example, the global branch history is updated when a prediction is generated, with a new entry in the global branch history reflecting the predicted branch (e.g., whether it is predicted that the branch will or will not be taken). The retirement branch history is used to calculate indexes for identifying the TAGE table entries to be updated based on whether the prediction was correct.

The method of FIG. 7 also includes updating 704 the retirement branch history based on a prediction for the branch instruction (e.g., the branch instruction being retired). For example, updating 704 the retirement branch history includes storing, in an entry, an indication of whether the prediction for the retiring branch instruction predicts a taken or not taken branch. In some embodiments, updating 704 the retirement branch history includes updating a head pointer for the retirement branch history to indicate the newest entry. In some embodiments, where the retirement branch history was full prior to updating, a tail pointer is updated to indicate the oldest entry in the retirement branch history as the previously oldest entry was overwritten or cycled out by the update. One skilled in the art will appreciate that the retirement branch history is updated after updating 702 the one or more TAGE tables as the particular TAGE table entries to be updated are identified using the retirement branch history. To do so, the retirement branch history must reflect the same state as the global branch history used to select TAGE table entries for generating the prediction. In other words, a pre-update global branch history is used to generate the prediction and then updated based on the prediction. On retirement of the branch instruction, a pre-update retirement branch history is used to index the TAGE tables the for updating, and then the retirement branch history is updated based on the prediction.

In view of the explanations set forth above, readers will recognize that the benefits of enforcing consistency across redundant TAGE branch histories include improved performance of a computing system by ensuring cohesion between redundant branch histories in a branch predictor, reducing performance degradation caused by variances in the redundant representations.

Exemplary embodiments of the present disclosure are described largely in the context of a fully functional computer system for enforcing consistency across redundant TAGE branch histories. Readers of skill in the art will recognize, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various embodiments of the present disclosure. The descriptions in this specification are for purposes of illustration only and are not to be construed in a limiting sense. The scope of the present disclosure is limited only by the language of the following claims.

What is claimed is:

1. A method of enforcing consistency across redundant tagged geometric (TAGE) branch histories, the method comprising:
determining, by a TAGE branch predictor, whether a predefined interval has occurred; and
storing, in a retirement branch history, in response to the predefined interval occurring, a copy of a global branch history.

2. The method of claim 1, further comprising updating, in response to retirement of a branch instruction, one or more TAGE tables based on the retirement branch history storing the copy of the global branch history.

3. The method of claim 2, further comprising updating the retirement branch history based on a prediction for the branch instruction.

4. The method of claim 3, wherein the prediction is based on the global branch history as copied into the retirement branch history.

5. The method of claim 1, wherein the predefined interval comprises a number of prediction cycles.

6. The method of claim 1, wherein the predefined interval comprises a time interval.

7. The method of claim 1, wherein the global branch history and the retirement branch history are each implemented as a circular buffer.

8. A TAGE branch predictor for enforcing consistency across redundant TAGE branch histories, comprising:
a global branch history;
a retirement branch history; and
wherein the TAGE branch predictor configured to perform steps comprising:
determining whether a predefined interval has occurred; and
storing, in a retirement branch history, in response to the predefined interval occurring, a copy of a global branch history.

9. The TAGE branch predictor of claim 8, wherein the steps further comprise updating, in response to retirement of a branch instruction, one or more TAGE tables based on the retirement branch history storing the copy of the global branch history.

10. The TAGE branch predictor of claim 9, wherein the steps further comprise updating the retirement branch history based on a prediction for the branch instruction.

11. The TAGE branch predictor of claim 10, wherein the prediction is based on the global branch history as copied into the retirement branch history.

12. The TAGE branch predictor of claim 8, wherein the predefined interval comprises a number of prediction cycles.

13. The TAGE branch predictor of claim 8, wherein the predefined interval comprises a time interval.

14. The TAGE branch predictor of claim 8, wherein the global branch history and the retirement branch history are each implemented as a circular buffer.

15. An apparatus for enforcing consistency across redundant TAGE branch histories, comprising:
computer memory;
a processor operatively coupled to the computer memory, the processor comprising a TAGE branch predictor configured to perform steps comprising:
determining whether a predefined interval has occurred; and
storing, in a retirement branch history, in response to the predefined interval occurring, a copy of a global branch history.

16. The apparatus of claim 15, wherein the steps further comprise updating, in response to retirement of a branch instruction, one or more TAGE tables based on the retirement branch history storing the copy of the global branch history.

17. The apparatus of claim 16, wherein the steps further comprise updating the retirement branch history based on a prediction for the branch instruction.

18. The apparatus of claim 17, wherein the prediction is based on the global branch history as copied into the retirement branch history.

19. The apparatus of claim 15, wherein the predefined interval comprises a number of prediction cycles.

20. The apparatus of claim 15, wherein the predefined interval comprises a time interval.
